(19) United States
(12) Patent Application Publication
(10) Pub. No.: US 2014/0025565 A1
(43) Pub. Date: Jan. 23, 2014

(54) SYSTEM AND METHOD FOR EMBEDDING FINANCIAL-VALUE ACCOUNT PROVISIONING AND MANAGEMENT FUNCTIONALITY WITHIN A DATABASE ACCOUNT MANAGEMENT SYSTEM

(71) Applicants: THERON RANDY FENNEL, ISSAQUAH, WA (US); DAVID LEEDS, SEATTLE, WA (US)

(72) Inventors: THERON RANDY FENNEL, ISSAQUAH, WA (US); DAVID LEEDS, SEATTLE, WA (US)

(21) Appl. No.: 13/735,270

(22) Filed: Jan. 7, 2013

Related U.S. Application Data
(63) Continuation-in-part of application No. 13/481,768, filed on May 25, 2012.

(51) Int. Cl. G06Q 20/28

(52) U.S. Cl. CPC G06Q 20/28
USPC 705/39

(57) ABSTRACT

A method and system are provided for integrating a the generation and communication of digitized data associated with a monetary credit account, such as a gift card account, with an account management suite, such as a sales automation system or a customer relationship management system. The invented method allows a user of an electronically accessible data base to create an assigned-value account that is pre-authorized for use with at least one designated merchant, credit card network, debit card network or financial services provider. The user may select from among a plurality of primary merchants, wherein the identification of the assigned-value account includes a branding association of a single primary merchant. Access to the established assigned-value account may be furnished to a beneficiary by an electronic communications network, whereby the beneficiary may receive and/or provide identity information required and sufficient to enable access to the assigned-value account.

### CO-PENDING PROVISIONAL PATENT APPLICATION

This Nonprovisional patent application is a Continuation-in-Part application to Nonprovisional patent application Ser. No. 13/481,768 filed on May 25, 2012. Nonprovisional patent application Ser. No. 13/481,768 is hereby incorporated by reference in its entirety and for all purposes, to include claiming benefit of the priority date of filing of Nonprovisional patent application Ser. No. 13/481,768.

### FIELD OF THE INVENTION

The present invention relates to information technology applied to electronically mediated financial account generation and management. More specifically, but not by way of limitation, embodiments of the present invention relate to creating, populating and deploying debit accounts or credit accounts in concert with an electronic communications network.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Use of transferrable assigned-value financial accounts has increased dramatically in recent years. Consumers may currently purchase or otherwise initiate assigned-value accounts and thereafter provide access to these accounts to beneficiaries of the initial purchasers choosing. In one common prior art practice, an assigned-value financial account may be associated with a virtual gift cards and/or hard copy gift cards. These prior art virtual gift card accounts and attendant physical gift cards may typically be assignable to any bearer or the physical card or person who merely demonstrates accessibility to the virtual gift card account. The prior art further enables authorization of access to a monetary value of these prior art financial accounts to enable purchase goods or services at associated merchants and/or be accepted by electronic network financial transaction participants, such as affiliates of credit or debit card accounts, such as a CITIBANK™, VISA™, MASTER CARD™, DISCOVER™ or AMERICAN EXPRESS™ systems or programs or retail store credit cards or programs offered or associated with retail operators, such as AMAZON™, MACYS™, SAKS FITH AVENUE™, J.C. PENNEY'S™ or the like.

Prior art gift cards provide a restricted monetary equivalent or scrip that is issued by retailers or banks to be used as an alternative to a non-monetary gift. Increasingly popular among the general public, gift cards ranked in year 2006 as the second-most given gift by consumers in the United States and the most-wanted gift by women, and the third-most wanted by males. Gift cards have become increasingly ubiquitous partially because their use relieves the benefactor of the gift card of the responsibility of selecting a specific gift. In addition, the gift card process enables a recipient, or beneficiary, of the gift card to expend and associated monetary value at his or her discretion within the restrictions set by the issuing agency.

Gift cards are often purchased and given as gifts by a benefactor who wishes to create or strengthen a personal, social or business relationship with a beneficiary-recipient of the gift card or a gifted monetary value account. Yet the prior art fails to optimally enable or encourage the association of identity data that is associable, or may be provided to, a beneficiary of an assigned-value financial account as intended by an original purchaser of the assigned-value financial account and/or a previously authorized beneficiary of an assigned-value financial account.

### SUMMARY AND OBJECTS OF INVENTION

It is an object of the invented method to provide a method and a system that enable the association and communication of identity information that enables access to a credit or a financial account value.

It is an optional object of the invented method to provide a method and a system that enable access to a credit or a financial account value by a party associated with the identity information.

It is an additional optional object of the invented method to provide a method and a system that enable access to a credit or a financial account value by a party that presents the identity information.

Towards these objects and other objects that will be made obvious in light of this disclosure, a system and method are provided for enabling a user of an electronically accessible data base to create an assigned-value account that is pre-authorized for use with at least one designated merchant, credit card network, debit card network or financial services provider. The user preferably may select from among a plurality of primary merchants, wherein the identification of the assigned-value account includes a branding association of a single primary merchant. It is also optionally preferable that access to the established assigned-value account may be furnished to a beneficiary by an electronic communications network, whereby the beneficiary may receive and/or provide identity information required and sufficient to enable access to the assigned-value account.

According to still other optional additional and/or alternate aspects of the invented method, the initial beneficiary may be enabled to further enable access to the assigned-value account by providing the identity information, or other information associated with the assigned-value account, to one or more other parties. The initial beneficiary and/or other parties may be any bearer of the identity information, a person or persons specifically identified by the identity information, and/or an organization. The identity information may consist of or comprise an authorizing character string that, when presented at a point of sale or via the electronics network, enables access to the associated assigned-value account. The assigned-value account may optionally be applied to secure ownership rights to or licenses of virtual or digitized assets.

According to even other optional additional and/or alternate aspects of the invented method, the use of the assigned-value account may be recordable and reportable via an electronic communications network, e.g., the Internet, a telephony network, and a computer communications network, to a primary merchant and/or a beneficiary organization associated with the assigned-value account. The invented additionally and optionally provides for publishing an account number of the assigned-value account on a physical card and providing the physical card to the beneficiary, wherein the physical card may be a gift card.

According to yet other optional additional and/or alternate aspects of the invented method, a system is provided that enables monitoring, authorizing, limiting and expanding the use of, and/or monetary redemption of, an assigned-value account by an account manager or by an automated process, whereby the value of the assigned-value account may be recognized or processed as a monetary value. The invented method preferably and optionally further enables the account manager to access interaction of the assigned-value account through the electronic network and/or in concert with a customer relationship management facility or a sales automation system.

According to additional optional and/or alternate aspects of the invented method, a system is provided that provides a client system using window user interfaces to both (a.) interact with a database system and (b.) generate, populate and communicate assigned-value accounts. The client system is preferably bi-directionally communicatively coupled with both a database system comprising the database and an electronics communications network, wherein identity information may be communicated to one or more beneficiary-candidates as directed by an account manager via the client system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a block diagram of an electronic communications network that bi-directionally communicatively couples an account management client system with a plurality of beneficiary systems, a plurality of merchant systems and optionally with a data base management system;

FIG. 2 is an illustration of a graphical user interface (hereinafter, “first GUI”) rendered in concert with an account management system, e.g. a sales automation system or a customer relationship management system, whereby an account manager is enabled to create, edit, modify, assign, authorize access to, monitor, manage and/or limit an assigned-value account;

FIG. 3 is an assigned-value account generation template as rendered by a system software of the client system of FIG. 1 in a generation of an assigned-value account of FIG. 2 in interaction with the account manager;

FIG. 4 is a flow chart of the client system of FIG. 1 in generating an assigned-value account in interaction with the account manager;

FIG. 5 is a flow chart of a interaction of the gift system with the network of FIG. 1;

FIG. 6 is a block drawing of a gift account record of an assigned-value account of FIG. 3 as initiated by the account manager in interaction with the customer relationship management system of FIG. 1 and updated in interaction with the network of FIG. 1;

FIG. 7 is a flowchart of a point of sale system of FIG. 1 in interaction with a bearer of information related to the assigned-value account of FIG. 2 and the electronics communications network of FIG. 1;

FIG. 8 is a flowchart of management activity enabled by the customer relationship management system of FIG. 1 and as driven by the account manager in effecting the assigned-value account of FIG. 2;

FIG. 9 is a block diagram of a single client system of FIG. 1;

FIG. 10 is a block diagram of a single point of sale system of FIG. 1;

FIG. 11 is a block diagram of a gift sale system of FIG. 1;

FIG. 12 is a schematic illustration of an exemplary first gift account record that relates to account information maintained in one or more of the systems, or accessible via the electronics communications network, of FIG. 1; and

FIG. 13 is a schematic illustration of an exemplary first gift message that is generated in the process of an instant purchase according to one aspect of invented method as enabled by the systems and electronics communications network of FIG. 1.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

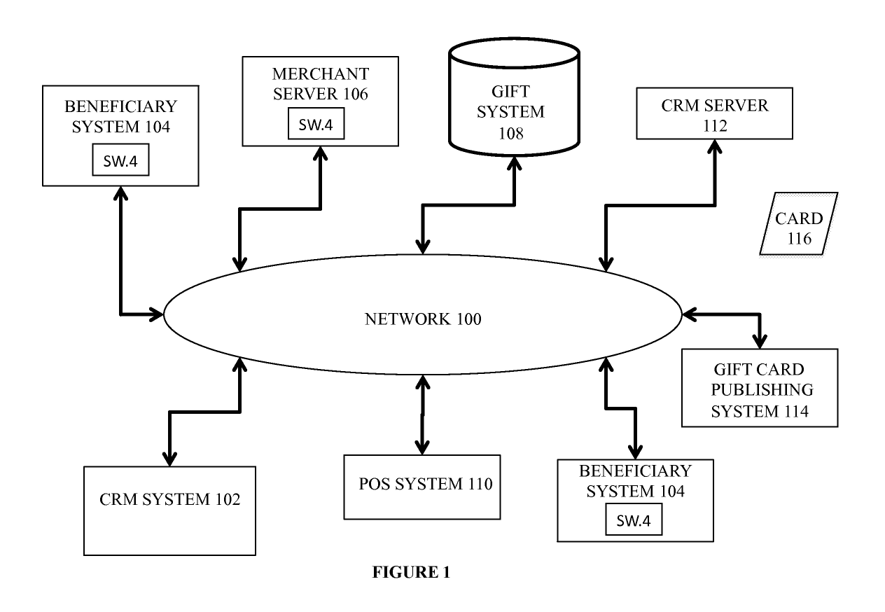

Referring now generally to the Figures and particularly to FIG. 1, FIG. 1 is a block diagram of an electronic communications network 100 that bi-directionally communicatively couples a customer relationship management client system 102 (hereinafter, “CRM system” 102) with a plurality of beneficiary systems 104, merchant servers 106, GIFT service systems 108, point of sale systems 110 and CRM database servers 112. One or more merchant servers 106 may be or comprise a server associated with a credit or debit card account service, such as a CITIBANK™, VISA™, MASTER CARD™, DISCOVER™ or AMERICAN EXPRESS™, and/or a retail store credit card operator, such as AMAZON™, MACYS™, SAKS FITH AVENUE™, J.C. PENNEY'S™ or the like.

The electronic communications network 100, or network 100, may be or comprise a telephony network, the Internet, a computer electronics network and/or a wireless communications network.

The CRM system 102 includes a gift service software SW.1 and an customer relationship management software SW.2, wherein the gift service software SW.1 enables the CRM system 102 to perform the aspects of the invented method as disclosed herein in interaction with an account manager and the computational systems 104-110 and software as identified herein. The account management software SW.2 preferably generates a multi-tenant database environment and may be a customer relationship management software, a sales automation software, and/or an element thereof. For example, the account management software SW.2 may rely upon an account management web service, such as a SALESFORCE.COM™, and/or a database server to interact with and manage the plurality of beneficiary systems 104. The gift service software optionally includes a with a gift account management module SW.4, and the gift account management module SW.4 authorizes, tracks and limits use of the exemplary gift account record 300. The CRM system 102 may interact with the CRM database server 112 in order to perform one or more aspects or steps of the invented method, wherein elements of the CRM software SW.2 and CRM multi-tenant database CRM SW.DBMS may be maintained or duplicated at one or more CRM database servers 112, e.g., by one or more CRM database servers 112 as provided by SALESFORCE.COM™ customer relationship management software services, or other suitable web-based or Internet-based distributed data base management services.

The network 100 enables the CRM system 102, the merchant systems 106, the GIFT system 108 and POS systems to allow a beneficiary to apply an assigned-value account to purchase a good or service. One or more POS systems 110 may be located at a brick and mortar retail sales outlet and one or more POS systems 110 may alternately or additionally be managed as a web service or virtual retail operation.

One or more CRM systems 102, beneficiary systems 104, merchant servers 106, gift account service systems 108 (hereinafter “GIFT systems” 108), point of sale systems 110 (hereinafter “POS systems” 110) or CRM database servers 112 may be or comprise (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable mobile electronic device, wireless communications device, computational system or electronic communications device known in the art.

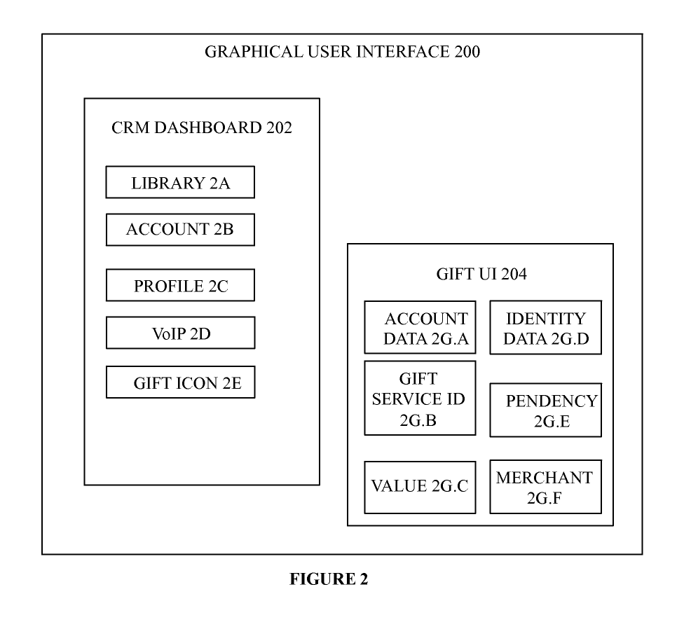

Referring now generally to the Figures and particularly to FIG. 2, FIG. 2 is an illustration of a graphical user interface 200 (hereinafter, “first GUI” 200) rendered by the CRM system 102 in concert with the account management system SW.2, e.g. a sales automation system or a customer relationship management system, whereby an account manager is enabled to create, edit, modify, assign, authorize access to, monitor, manage and/or limit an assigned-value account. An account management dashboard includes 202 several windows 2A-2F, including an account library window 2A, an account data window 2B, a contact profile window 2C, a voice-over-Internet portal utility 2D and a gift account icon 2E. Preferably, the gift icon 2E is rendered in visual association with a contact profile window 2C wherein a selection of the gift icon 2E by the account manager directs the gift service software SW.1 to render the gift account user interface 204 and to populate one or more essential or optional gift account data fields 2G.A-2G.D. Information input into the gift account data fields 2G.A-2G.D is stored in a gift account record G.REC.1-G.REC.N.

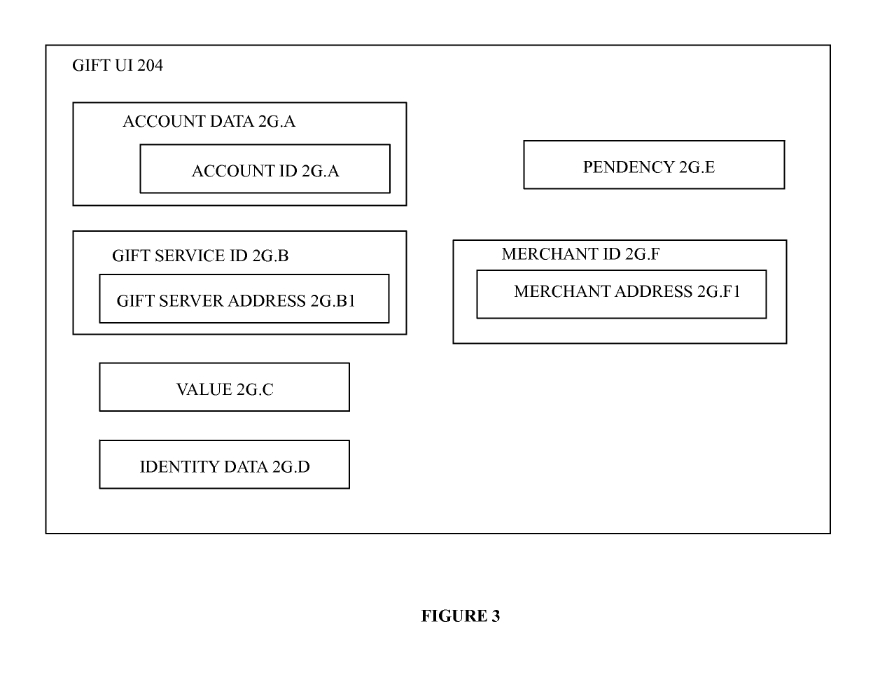

Referring now generally to the Figures and particularly to FIG. 3, FIG. 3 is a detailed view of the gift account user interface 204 more particularly showing a plurality of gift account data fields 2G.A-2G.F. The account data field 2G.A optionally includes information harvested from the CRM software SW.2 to establish an exemplary gift account record 300. The gift service data field 2G.B identifies a gift service assignable to the exemplary gift account record 300 and may include a network address 2G.B1 of a gift account service provider system 108. The value data field 2G.0 accepts a numerical gift value assigned by an account manager, such as a monetary value or a reward value, to the exemplary gift account record 300. The identity data field 2G.D includes information that is used in the invented method and system to authorize an expenditure from the exemplary gift account record 300. A pendency data field 2G.E accepts data indicating a term of validity of the value of the exemplary gift account record 300. A merchant identifier data field 2G.F includes information that associates a merchant with the exemplary gift account record 300 and may further include a network address 2G.F1 of a merchant server 106.

It is understood that the exemplary gift account record may be or comprise a gift account record G.REC.1-G.REC.N or may comprise any combination of data fields or informational content of one or more gift account records G.REC.1-G.REC.N or one or more gift account messages M.REC.1-M.REC.N.

Alternatively and/or additionally the gift service software SW.1 may automatically populate the selections of value account reference, organization identifier, identity information and transmittal address from one or more CRM account records SW.2.REC.1-SW.2.REC.N of the account management software SW.2. The account manager may input the assigned monetary value of the gift account, select the primary and secondary merchants and a gift card management service, and enter in a transmittal network address to where an assigned value message shall be directed. One or more gift account records 300 & G.REC.1-G.REC.N may be populated with information harvested from the account management software SW.2, a CRM database server 112, and/or input into the CRM system 102.

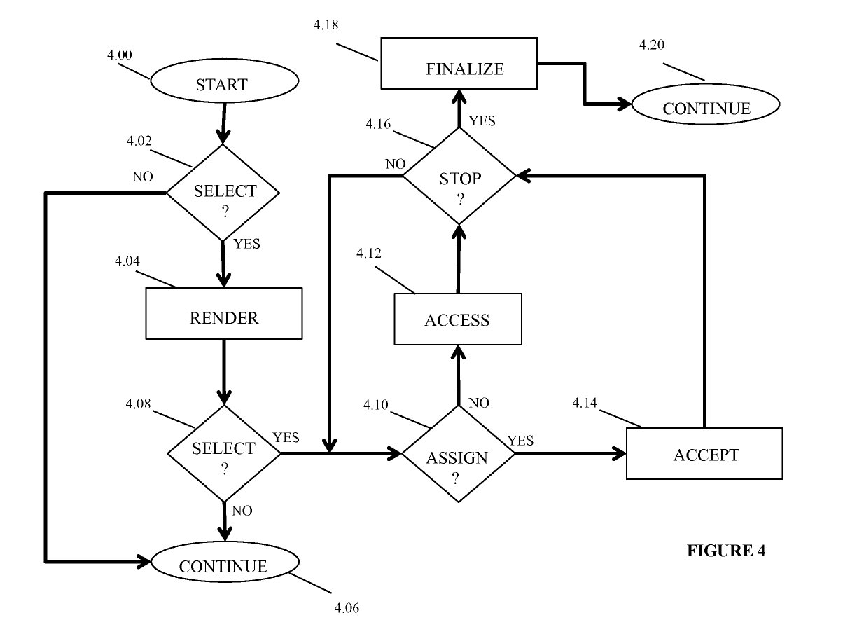

Referring now generally to the Figures and particularly to FIG. 4, FIG. 4 is flow chart of the method of generation of the exemplary gift account record 300. In step 4.00 the CRM software SW.2 generates the CRM GUI 200 and in step 4.02 the CRM system 102 determines if the user has selected the GIFT icon 2E as rendered within the CRM GUI 200. When the CRM system 102 determines that the user has selected the GIFT icon 2E, the CRM system 102 proceeds from step 4.02 to step 4.04 to render the gift UI 204 in step 4.04. Alternatively, CRM software SW.2 proceeds from step 4.02 to step and to perform alternate computational operations.

In step 4.08 the CRM software 102 determines if the user has selected a data field dialogue box 2G.A-2G.F. When the CRM system 102 determines that the user selected a data field dialogue box 2G.A-2G.F, the CRM system 102 proceeds from step 4.08 to step 4.10 determine whether to access an earlier recorded in value in step 4.12 or accept a user provided value in step 4.14. The CRM system 102 determines in step 4.16 whether to complete populating the exemplary gift account record 300 in step 4.18 or to process another execution of the loop of step 4.10 through 4.16. When the CRM system 102 proceeds to step 4.18, the CRM system 102 informs a beneficiary system of the assignment of the gift account record 300 whereby an intended beneficiary of the exemplary gift account record 300 is notified.

The CRM system 102 proceeds from step 4.18 to step 4.20 to perform alternate computational operations. Optionally or additionally, the CRM system 102 may direct a gift card publishing system 114 via the network 100 to generate a gift card 116 bearing the gift account number and issue the gift card 116 to an intended beneficiary. The gift card 116 may be delivered by United States Post or other hard copy document delivery service or means known in the art.

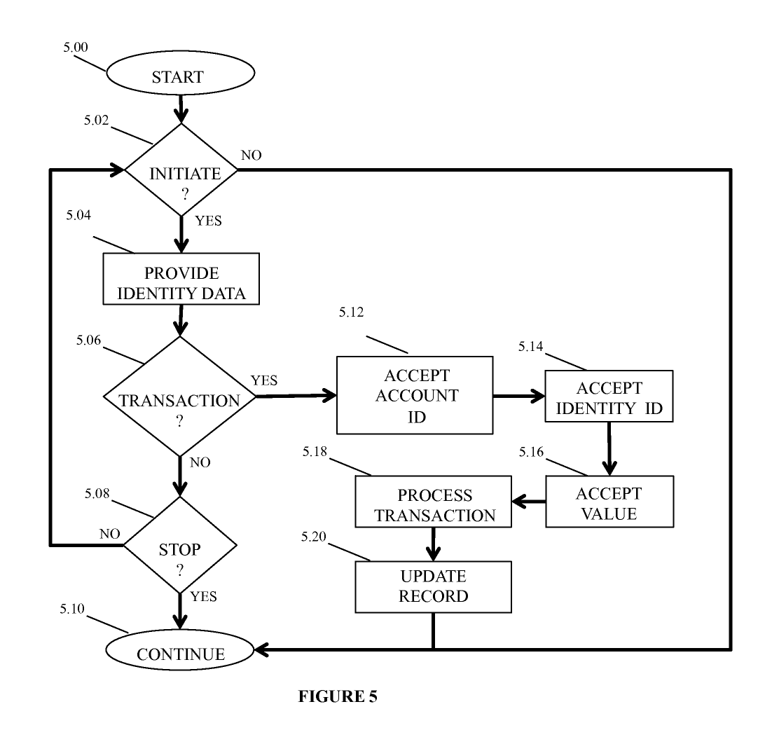

Referring now generally to the Figures and particularly to FIG. 5, FIG. 5 is a flow chart of an interaction of the gift system 108 with the network 100. In step 5.02 the gift system is informed that the CRM system is assigning an identity data to the exemplary gift account record 300. In step 5.04 the gift system 108 receives the identity data from the CRM system 102 and associates the identity data with the exemplary gift account record 300. In step 5.06 the gift account determines if a transaction related to the exemplary gift account record 300 has been requested. If no transaction request is detected by the gift system 108 in step 5.08, the gift system 108 proceeds on to step 5.10 and to perform alternate computational operations in step 5.10.

When a transaction request is detected by the gift system 108 in step 5.08, the gift system 108 proceeds on to step 5.12 and to accept an account identifier in step 5.12, an identity information in step 5.14, and a monetary value in step 5.16. The gift system 108 processes the requested transaction in step 5.18 and updates the exemplary account record 300 in step 5.20. The gift system 108 proceeds on to step 5.10 from step 5.20 and to perform alternate computational operations.

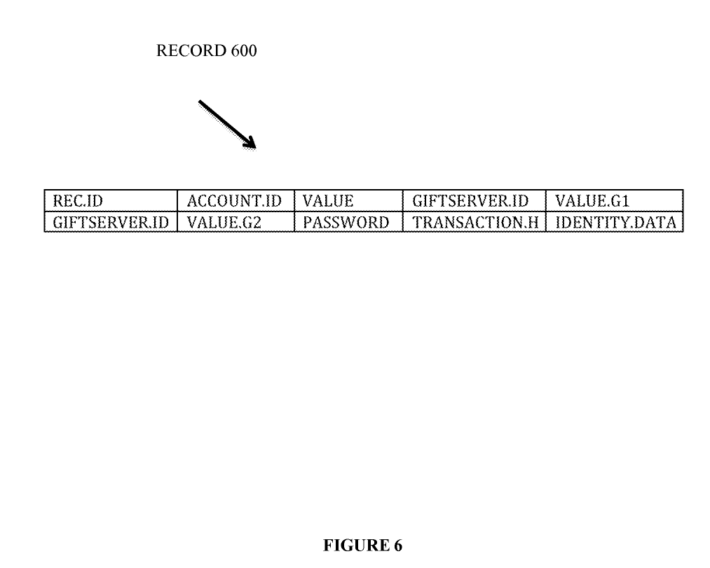

Referring now generally to the Figures and particularly to FIG. 6, FIG. 6 is a block drawing an exemplary gift account record 600 as initiated by the account manager in interaction with the CRM system 102 and updated in interaction with the network 100. The gift account record 600 includes a record identifier REC.ID, an account identifier ACCOUNT.ID and an assigned value VALUE. The exemplary record 600 may further include one or more values VALUE.G1 & VALUE.G2 assigned to individual gift systems 108, an optional access code such as a password, a transaction history TRANSACTION.H and an optional identity data IDENTITY.DATA. The transaction history TRANSACTION.H may include information regarding updates to the exemplary gift account record 600 and transactions data related to the exemplary gift account record 600.

The identity data IDENTITY.DATA may be an access code, a password, an account identifier, an organization identifier, a data or datum associated with an entity or an organization or a personal datum or data. When the identity data IDENTITY.DATA is or comprises a personal datum or data, the identity data IDENTITY.DATA may be or comprise a datum or data associated with, or associable with, an intended beneficiary or individual, such as a social security number, a driver's license, a login name, a customer number, an email address, and/or other identifier known in the art. Optionally and additionally, the identity data IDENTITY.DATA may specify a reporting requirement of the gift card account use to a system 102-110 via the network 2.

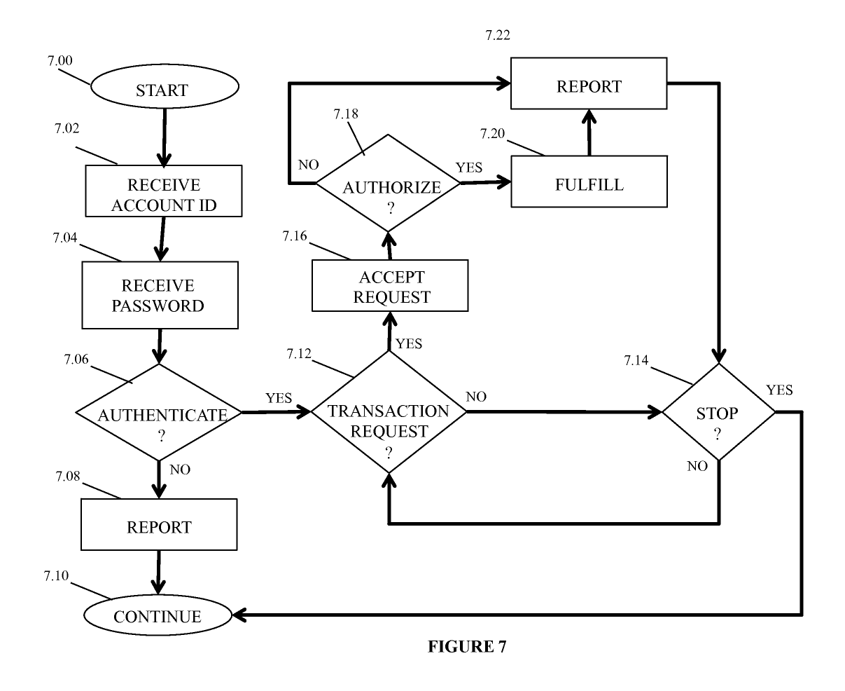

Referring now generally to the Figures and particularly to FIG. 7, FIG. 7 is a flowchart of a POS system 110 in interaction with a bearer of information related to the exemplary assigned-value account record 300 and the network 100. In step 7.02 the POS system 110 receives an account identifier from a possible purchaser and in step 7.04 the POS system 110 receives an identity information applied as an access code, e.g., a password. The access code may be an account number, a personal data associated with a particular person, e.g., a social security number, driver's license number, a user name, an account name of a social networking service, e.g., a TWITTER™ name, an email address, or simply a datum or data that is recognized by one or more systems 102-110 to authorize access to a gift account or financial value to a party presenting the access code.

The POS system 110 communicates with the network 100 and attempts to authenticate the received account identifier, identity data IDENTITY DATA, access code and/or password in step 7.06 and proceeds on to step 7.08 to report a failure of authentication to the CRM system 102 and/or gift system 108 when no authentication is received from the network 100. The POS system 110 proceeds on to step 7.10 from step 7.08 and to perform alternate computational operation. When the POS system 110 receives authentication via the network 100 in step 7.06, the POS system 110 proceeds on to determine if a transaction has been requested in step 7.12, and when no transaction request has been detected in step 7.12 proceeds on step 7.14. The POS system 110 determines in step 7.14 whether to proceed to step 7.10 or back to step 7.12 on the basis of either user input or a timed out condition.

The POS system 110 accepts the transaction request in step 7.16 and then attempts to authorize the exemplary transaction request in step 7.18 by interaction with the network 100, e.g., through communication with a merchant server 106, the gift system 108 and/or the CRM system 102. When the exemplary transaction request is authorized in step 7.18, the POS system 110 fulfills the request by electronic messaging in step 7.20 and reports the transaction via the network 100 in step 7.22 to a CRM account tracking software module SW.3, optionally to a GIFT account tracking software module SW.3 of the gift system 108. It is understood that the transaction request of step 7.12 may specify a request to purchase a digital asset SW.4, such as a video document, audio file, or license to a digitally encoded record or document, and that step 7.20 may comprise delivering the digital asset SW.4 via the network 100 or enabling access to a digital asset SW.4 via the network 100 and/or delivering the digital asset SW.4 from a merchant server 106 to a beneficiary system 104.

Alternately, when the exemplary transaction request is not authorized in step 7.18, the POS system 110 reports the failure of the transaction to the network 100 in step 7.22. The POS system 110 proceeds from step 7.22 to step 7.14.

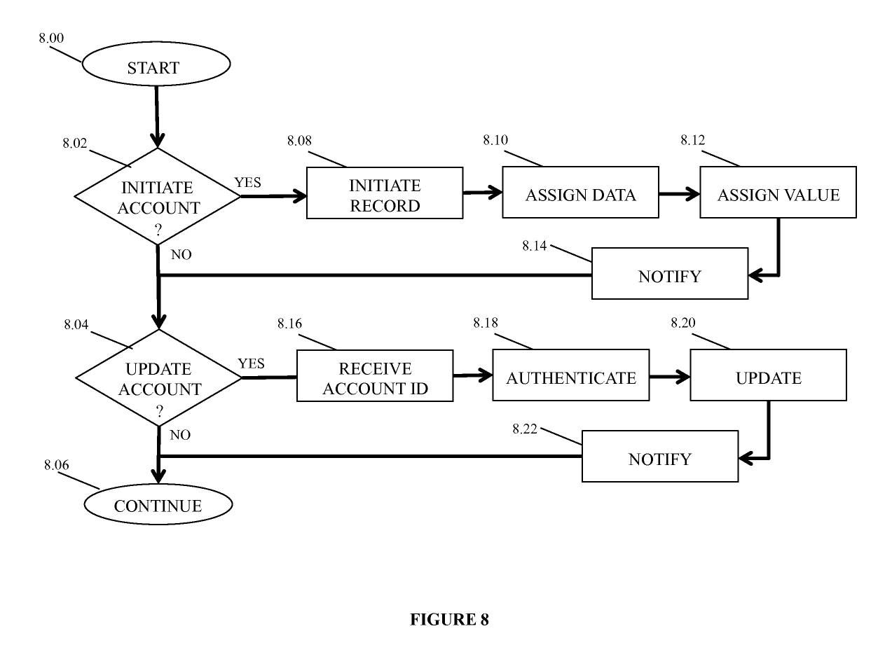

Referring now generally to the Figures and particularly to FIG. 8, FIG. 8 is a flowchart of management activity enabled by the CRM system 102 and as driven by the account manager in effecting the exemplary assigned-value account record 300. The CRM system 102 determines in step 8.02 if an account initiation has been requested and when no account initiation request had been received, the CRM system 102 proceeds on to step 804. The CRM system 102 determines in step 8.04 if an account update message has been received and when message has been detected, the CRM system 102 proceeds on to step 806 to perform alternate computational operations.

When the CRM system 102 determines in step 8.02 that an account initiation has been requested, the CRM system 102 proceeds on to step 8.08 to initiate a gift account record and assigns an account identifier and identity information to the newly formed gift account in step 8.10. The CRM system 102 further assigns a monetary or other quantitative credit value to the newly formed gift account record in step 8.12. The CRM system 102 then notifies the gift system 108 in step 8.14. When the CRM system 102 determines in step 8.04 that an account update message has been received via the network 100, the CRM system 102 proceed to step 8.16 to receive an account identifier. When the update message received in step 8.06 is authenticated in step 8.18 the relevant gift account record 300 is updated in step 8.20 and the CRM system 102 notifies the gift system 110 in step 8.22 of the update message received in is step 8.04.

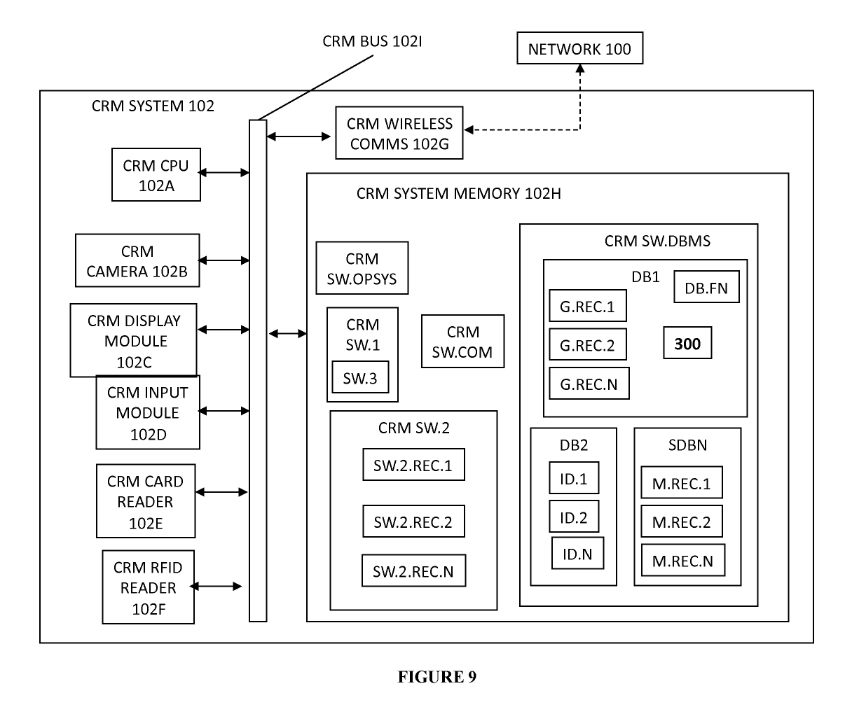

Referring now to FIG. 9, FIG. 9 is a schematic of the CRM system 102. The CRM system 102 includes a CRM central processing unit 102A, an optional CRM digital camera 102B, a CRM output display module 10C that includes a display screen, a CRM input module 10D, an optional CRM card reader 102E, an optional CRM RFID reader 102F, an optional CRM wireless communications module 102G, and a CRM system memory 102H. The CRM central processing unit 102A, the CRM digital camera 102B, the CRM output display module 102C, the CRM input module 102D, the CRM card reader 102E, the CRM RFID reader 102F, the CRM wireless communications module 102G, and the CRM system memory 102H are bi-directionally communicatively coupled by a CRM internal communications bus 1021. A CRM operating system software SW.OPSYS enables the CRM system 102 to coordinate and employ the software SW.1, SW.2, SW.COM & SW.DBMS and elements 102A-102I of the CRM system 102 in accordance with the invented method.

The CRM software SW.2 may be a commercially available customer relationship or sales management software module or product such as a suitable software code or product offered by Salesforce.com of San Francisco, Calif., SAP AG of Walldorf, Germany, Oracle Corporation of Santa Clara, Calif., or other suitable commercially available customer relationship or sales management software.

A CRM communications software SW.COM enables the CRM network communications module 102G to bi-directionally couple the CRM system 102 with the network 100.

A CRM multi-tenant database management system software SW.DBMS includes a plurality of CRM multi-tenant databases DB1-DBN that may individually or in combination contain, in whole or in part, a plurality of gift account records G.REC.1-G.REC.N, a plurality of gift messages M.REC.1-M.REC.N, and a plurality of identification data records ID.1-ID.N. The plurality of identification data records ID.1-ID.N may be used to attest to the identity of the beneficiary when requesting a purchase on the basis of a gift card 2 or a gift account record G.REC.1-G.REC.N.

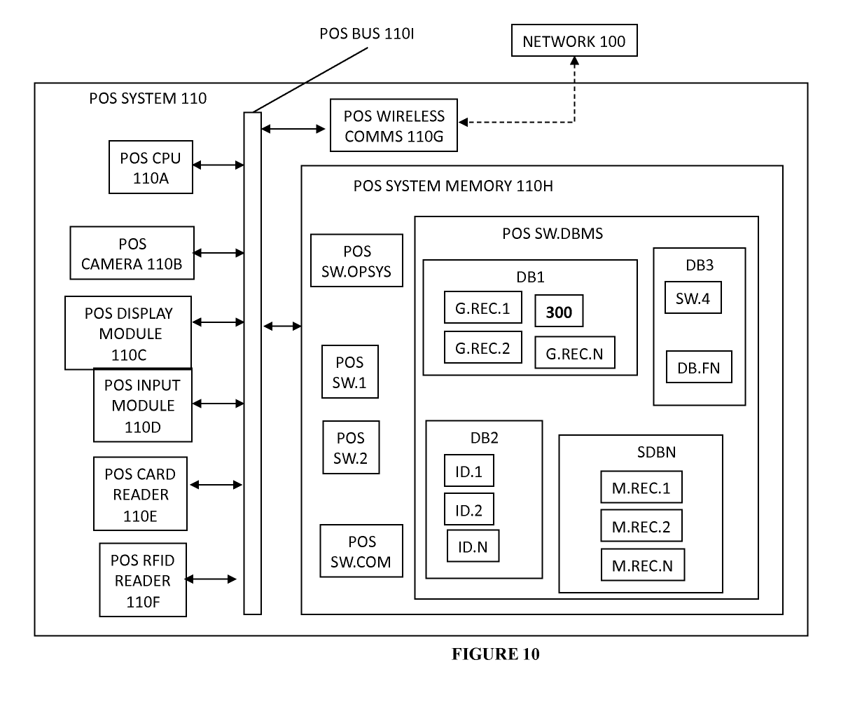

Referring now to FIG. 10, FIG. 10 is a schematic of the POS system 110. A POS software POS SW.1 enables directs the POS system 110 to execute or instantiate one or more aspects or steps of the invented method. More particularly, the POS transactional software POS SW.1 enables and directs the POS system 110 to execute or instantiate one or more communications of invented method, in isolation or in concert with the network 100, as disclosed in FIGS. 2 through 8, to include financial transactions and sales, purchasing, and purchase fulfillment processing.

The POS system 110 includes a POS central processing unit 110A, a POS digital camera 110B, a POS output display module 10C that includes a display screen, a POS input module 10D, a POS card reader 110E, a POS RFID reader 110F, a POS wireless communications module 110G, and a POS system memory 110H. The POS central processing unit 110A, the POS digital camera 110B, the POS output display module 110C,the POS input module 110D, the POS card reader 110E, the POS RFID reader 110F, the POS wireless communications module 110G, and the POS system memory 110H are bi-directionally communicatively coupled by a POS internal communications bus 110I. A POS operating system software SW.OPSYS enables the POS system 110 to coordinate and employ the software POS SW.1, POS SW.2, POS SW.COM & POS SW.DBMS and elements 110A-110I of the POS system 110 in accordance with the invented method.

A POS communications software POS SW.COM enables the POS network communications module 110G to bi-directionally couple the POS system 110 with the network 100. A POS database management system software POS SW.DBMS optionally includes a plurality of POS databases DB1-DBN that may individually or in combination contain, in whole or in part, a plurality of gift account records G.REC.1-G.REC.N, a plurality of gift messages M.REC.1-M.REC.N, and a plurality of identification data records ID.1-ID.N. The plurality of identification data records ID.1-ID.N may be used to attest to the identity of the beneficiary when requesting a purchase on the basis of a gift card 2 or a gift account record G.REC.1-G.REC.N.

It is understood that one or more beneficiary systems 104 may comprise one, some or all of the software POS SW.1, POS SW.2, POS SW.COM & POS SW.DBMS and elements 110A-1101 of the POS system 110.

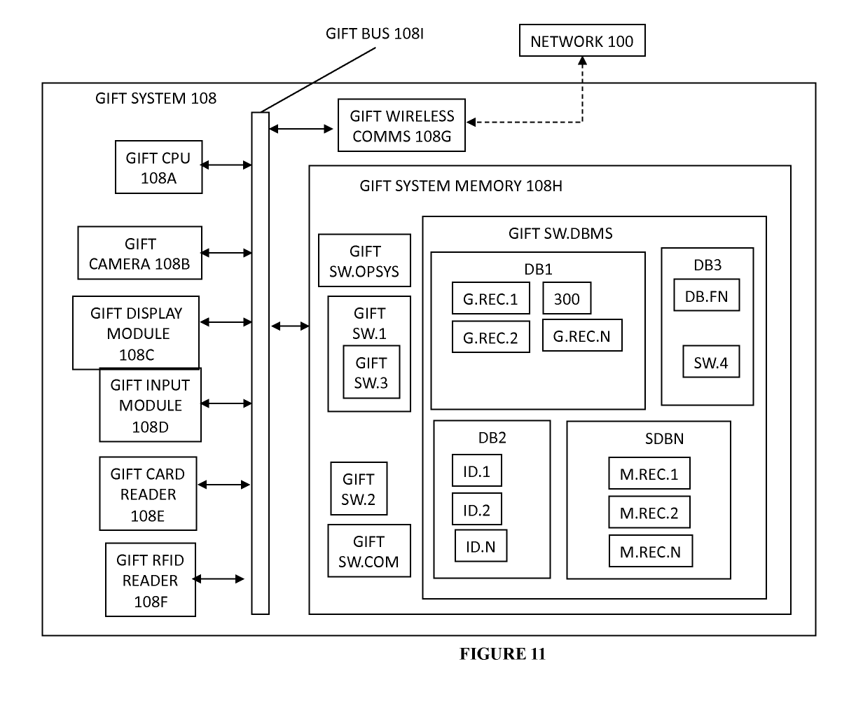

Referring now to FIG. 11, FIG. 11 is a schematic of the GIFT system 108. A GIFT software GIFT SW.1 enables directs the GIFT system 108 to execute or instantiate one or more aspects or steps of the invented method, in isolation or in concert with the network 100 and systems 102-110, as disclosed in FIGS. 2 through 8. In addition, a GIFT communications and documentation software GIFT SW.2 enables and directs the GIFT system 108 to document, enable, execute or instantiate one or more communications, steps or aspects of invented method, in isolation or in concert with the network 100 and system 102-110, as disclosed in FIGS. 2 through 8.

The GIFT system 108 includes a GIFT central processing unit 108A, an optional GIFT digital camera 108B, a GIFT output display module 10C that includes a display screen, a GIFT input module 10D, an optional GIFT card reader 108E, an optional GIFT RFID reader 108F, an optional GIFT wireless communications module 108G, and a GIFT system memory 108H. The GIFT central processing unit 108A, the GIFT digital camera 108B, the GIFT output display module 108C, the GIFT input module 108D, the GIFT card reader 108E, the GIFT RFID reader 108F, the GIFT wireless communications module 108G, and the GIFT system memory 108H are bi-directionally communicatively coupled by a GIFT internal communications bus 1081. A GIFT operating system software SW.OPSYS enables the GIFT system 108 to coordinate and employ the software GIFT SW.1, GIFT SW.2, GIFT SW.COM & GIFT SW.DBMS and elements 108A-1081 of the GIFT system 108 in accordance with the invented method.

A GIFT communications software GIFT SW.COM enables the GIFT network communications module 108G to bi-directionally couple the GIFT system 108 with the network 100. A GIFT database management system software GIFT SW.DBMS optionally includes a plurality of GIFT databases DB1-DBN that may individually or in combination contain, in whole or in part, a plurality of gift account records G.REC.1-G.REC.N, a plurality of gift messages M.REC.1-M.REC.N, and a plurality of identification data records ID.1-ID.N. The plurality of identification data records ID.1-ID.N may be used to attest to the identity of the beneficiary when requesting a purchase on the basis of a gift card 2 or a gift account record G.REC.1-G.REC.N.

It is understood that one or more merchant systems 106 may comprise one, some or all of the software GIFT SW.1, GIFT SW.2, GIFT SW.COM & GIFT SW.DBMS and elements 108A-1081 of the GIFT system 108.

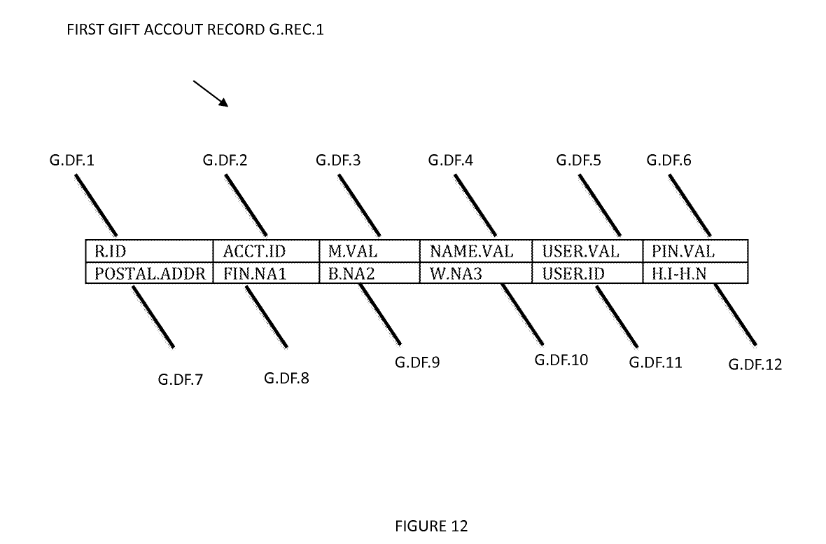

Referring now to FIG. 12, FIG. 12 is a schematic illustration of an exemplary first gift account record G.REC.1 that may be generated, stored, updated and maintained by the CRM system 102 and/or the gift system 108 in isolation or in combination with the network 2 and other systems 102-110. It is understood that one or more additional gift account records G.REC.2-G.REC.N may comprise one, some or all of the gift data fields G.DF.1-G.DF.12 and contain information respectively relating to one or more alternate gift accounts.

The first gift data field G.DF.1 includes a record identifier R.ID of the instant gift account record G.REC.1. The second gift data field G.DF.2 contains an account identifier ACCT.ID that uniquely identifies an exemplary first gift account. A third gift account data field G.DF.3 records an adjustable monetary value M.VAL. A fourth gift data field G.DF.4 includes an actual name value NAME.VAL of a person to whom ownership or control of a credit or debit account identified by the instant account identifier ACCT.ID is assigned. It is understood that the actual name value NAME.VAL may be a pseudonym or a name shared by two or more entities. A fifth gift data field G.DF.5 contains a user name value USER.VAL. A sixth gift data field G.DF.6 contains a personal identification number value PIN.VAL. A seventh gift data field G.DF.7 contains a postal address POSTAL.ADDR related to or supplied by a person or entity identified by or associated with the actual name value NAME.VAL contained in the fourth gift data field G.DF.4. An eighth fourth gift data field G.DF.8 includes a first financial services network address FIN.NA1 of a merchant server 106. A ninth gift data field G.DF.9 includes a benefactor network address B.NA2 of a benefactor who provided the exemplary first gift card account to the beneficiary. A tenth gift data field G.DF.10 includes a web address W.NA3 of a photo sharing webservice server 15. An eleventh gift data field G.DF.7 includes a user identifier USER.ID that identifies, or is associable with, the beneficiary of the exemplary first gift account and/or a network address related to the beneficiary. A twelfth gift history data field G.DF.12 includes history data H.1-H.N related to the instant exemplary first gift account. It is understood that the network addresses referred to herein may be an email address, a social networking account name address, a small message service address, an account name of the TWITTER™ social networking service, a texting address or a telephone number. It is further understood that the one or more of the contents first gift data field G.DF.1 and the third gift data field G.DF.3 through the twelfth gift data field G.DF.12 may be optional in one or more various preferred embodiments of the invented method.

It is understood that the account identifier ACCT.ID, the actual name value NAME.VAL the user name value USER.VAL, and/or the personal identification number value PIN.VAL may be presented in step 7.04 of the process of FIG. 4 as the password that authorizes access to a gift account, a credit, and/or a financial value account.

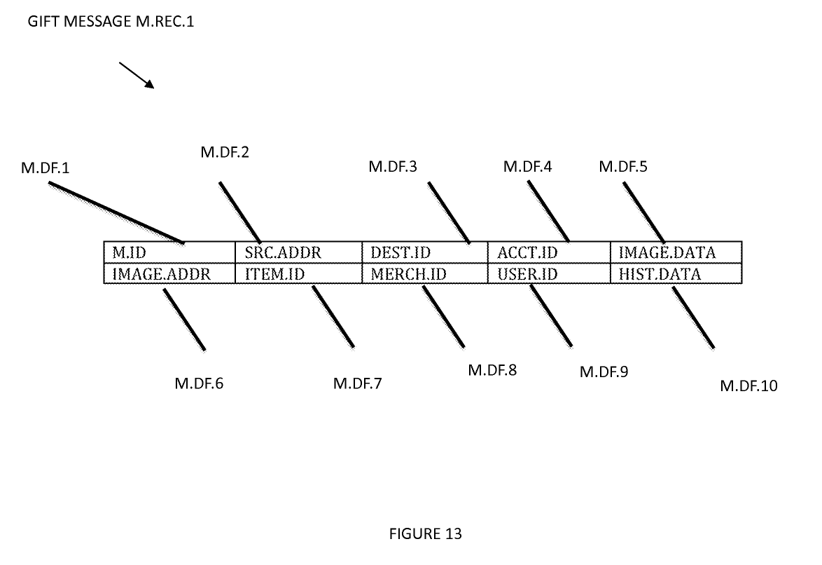

Referring now to FIG. 13, FIG. 13 is a schematic illustration of an exemplary first gift message M.REC.1 that is generated in the process of an instant purchase according to one aspect of invented method, and optionally applied in steps 7.04 through 7.18 of the process of FIG. 7. The gift message M.REC.1 may be generated by a beneficiary system 104 or a POS system 110 and sent to the CRM system 102, one or more merchant systems 106, and/or one or more one or more gift systems 108.

It is understood that one or more additional gift messages M.REC.2-M.REC.N may comprise one, some or all of the message data fields M.DF.1-M.DF.10 and contain information respectively relating to one or more alternate purchases. The first message data field M.DF.1 includes a message identifier M.ID of the instant gift message M.REC.1. The second message data field M.DF.2 contains a message sender address SRC.ADDR, or source address, that uniquely identifies a network address of an originator of the instant first gift message M.REC.1, i.e. a network address of the POS system 110 or a network address of the beneficiary system 104. A third gift account data field M.DF.3 specifies a destination address DEST.ADDR of the instant gift message M.REC.1, e.g., a network address the financial server network address FIN.NA1, the benefactor network address B.ADDR, or the photo-share webservice server W.NA3. A fourth message data field M.DF.4 includes the gift account identifier ACCT.ID from which a monetary value is deducted in the execution of the instant purchase. A fifth message data field M.DF.5 includes an image document IMAGE.DATA that relates to an item purchased in the instant purchase, e.g., a digitized photograph of the item purchased or of a generic image of the item purchased. A sixth message data field M.DF.6 includes an image network address IMAGE.ADDR at where a digitized representation of an image related to the instant purchase may be found, e.g., the network address W.ADDR.3 of the photo sharing webservice server 15. A seventh message data field M.DF.7 includes an item identifier ITEM.ID that uniquely identifies the item ITEM.1-ITEM.N purchased in the instant purchase, either generically or by unit-specific identification. It is understood that the purchased item ITEM.1-ITEM.N may be a good or a service, or a license, lease, or permission to use or access a good, service, equipment, locale or venue.

An optional eighth gift history data field M.DF.8 includes merchant identified MERCH.ID that identifies the merchant entity or merchant server 106 with which the instant purchase was executed. An optional ninth user identifier data field M.DF.9 includes the user identifier USER.ID of the exemplary first gift account record G.REC.1. An optional tenth gift message history data field M.DF.10 includes account information supplied by a user of the instant gift card 2 or instant gift account identified by the account identifier ACCT.ID or read by the POS system 10 or the mobile device 8 directly from the gift card 2, wherein account information may be or include such as (a.) a valid password that may be presented in step 7.04 to achieve a positive authentication of step 7.06 as per the process of FIG. 7; (b.) the actual name value NAME.VAL; (c.) the user name value USER.VAL; (d.) personal identification number value PIN.VAL; and/or (e.) the postal address POSTAL.ADDR. Alternatively or additionally, the user identifier USER.ID or the account identifier ACCT.ID may comprise or constitute a valid password or access code that that may be presented in step 7.04 to achieve a positive authentication of step 7.06 as per the process of FIG. 7.

The foregoing disclosures and statements are illustrative only of the Present Invention, and are not intended to limit or define the scope of the Present Invention. The above description is intended to be illustrative and not restrictive. Although the examples given herein include many specificities, they are intended as illustrative of only certain possible configurations or aspects of the Present Invention. The examples given should only be interpreted as illustrations of some of the preferred configurations or aspects of the Present Invention and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

1. In a multi-tenant database environment, including a multi-tenant database that stores data and identity information for a plurality of organizations, a computer-implemented method comprising:
generating an account interface, the account interface enabling access to the multi-tenant database by an account manager;
rendering a gift account provisioning user interface window (“window”) within the user interface, the window enabling the account manager to assign a gift account having a monetary value to a beneficiary in accordance with identity information accessible by the multi-tenant database;
as directed by commands and data received via the window, assigning a gift account to a beneficiary in accordance with selected identity information within the multi-tenant database; and
notifying a beneficiary of the assignment of the gift account.

2. The method of claim 1, wherein the beneficiary is a human being identified in the assigned gift account.

3. The method of claim 1, wherein the selected identity information identifies at least one person and usage of the assigned gift account is authorized to the at least one person.

4. The method of claim 1, wherein the selected identity information identifies an organization and usage of assigned gift account is authorized to the organization.

5. The method of claim 1, wherein the beneficiary is defined as any provider of a password at a point of sale and the notification of the beneficiary comprises communicating the password to a person in accordance with selected identity information.

6. The method of claim 1, wherein the account manager accesses usage and history information of the assigned gift account as maintained by a gift account management module by means of interacting with the window.

7. The method of claim 1, wherein the multi-tenant database is comprised within a customer relationship management system.

8. The method of claim 1, wherein the multi-tenant database is comprised within a sales automation system.

9. The method of claim 1, further comprising communicating both a gift account number and an access code of the assigned gift account via an electronics communication network to the beneficiary.

10. The method of claim 9, wherein the term beneficiary is defined to include any provider of the access code at a point of sale.

11. The method of claim 10, further comprising communicating an access code of the assigned gift account via an electronics communication network to a beneficiary system.

12. The method of claim 11, wherein the term beneficiary is defined to include any provider of the access code at a point of sale.

13. The method of claim 1, wherein the gift account specifies a monetary value.

14. The method of claim 1, wherein the gift account specifies a monetary value redeemable as an equivalent to financial currency.

15. The method of claim 1, wherein the gift account specifies a reward value that is applicable to purchase control of a digital asset.

16. A computer system, comprising:
a. a database system storing data and records for multiple organizations;
b. a network interconnect; and
c. a client device, having a processor, wherein the processor executes logic that is operable to control the database system to:
i. generate an account interface, the account interface enabling access to the multi-tenant database by an account manager;
ii. render a gift account provisioning window (“window”) within the user interface, the window enabling the account manager to assign a gift account having a monetary value to a beneficiary in accordance with an identity information of the multi-tenant database;
iii. as directed by commands and data received via the window, assign a gift account to a beneficiary in accordance with a selected identity information of the multi-tenant database; and
iv. notify a beneficiary system of the assignment of the gift account.

17. The system of claim 16, wherein the beneficiary is a human being identified in the assigned gift account.

18. The system of claim 16, wherein the selected identity information identifies at least one person and usage of assigned gift account is authorized to the at least one person.

19. The system of claim 16, wherein a status of the beneficiary includes any provider of the access code at a point of sale.

20. A method for transmitting code to share an application in a multi-tenant database environment, including a multi-tenant database, over a machine accessible transmission medium, the method including transmitting code that causes one or more processors to of a client system to perform the following:
a. generate an account interface, the account interface enabling access to the multi-tenant database by an account manager;
b. render a gift account provisioning window (“window”) within the user interface, the window enabling the account manager to assign a gift account having a monetary value to a beneficiary in accordance with an identity information of the multi-tenant database;
c. as directed by commands and data received via the window, assign a gift account to a beneficiary in accordance with a selected identity information of the multi-tenant database; and
d. notify a beneficiary system of the assignment of the gift account.
